(19) United States
(12) Patent Application Publication
(10) Pub. No.: US 2023/0228607 A1
(43) Pub. Date: Jul. 20, 2023

(54) ACTIVE FILTER STATUS MONITOR

(71) Applicant: Dell Products L.P., Round Rock, TX (US)

(72) Inventors: Eric Michael Tunks, Austin, TX (US); Michael Albert Perks, Austin, TX (US); John Randolph Stuewe, Round Rock, TX (US); Todd Charles Oiesen, Pflugerville, TX (US)

(21) Appl. No.: 17/577,614

(22) Filed: Jan. 18, 2022

(51) Int. Cl. G01F 15/02; G01F 15/12; G05F 1/625

(52) U.S. Cl. CPC G01F 15/022; G01F 15/125; G05F 1/625

(57) ABSTRACT

Embodiments of the present disclosure disclose a method and associated device for determining when an air filter needs replaced in an electronic device. The method comprises measuring the power needed to produce a predetermined output in a fan or related device that receives air through the air filter and comparing the measured power to previous measurements. When the amount of power needed is greater than a threshold, a dirty filter message or alert is produced.

### BACKGROUND

Electronic devices such as servers and computers require circulating air or other gasses in order to cool them. Often this air is moved by multiple fans which have air filters for filtering the air that is moved by the fans. When operating the fans, the filters get dirty and/or clogged over time depending on the local environment. Therefore in order to keep the fans and computing equipment operating in an efficient manner, manufactures recommend replacing the filters on a fixed schedule.

When the fans are operated in a less than ideal environment, the manufacture's recommended schedule may not be appropriate. Alternatively, when operated in a more pristine environment, the filters may not need to be replaced as often. To overcome this, sensors can be added to determine if and when the filters have become clogged. However, such sensors are expensive, and their installation can increase the cost of the electronic devices.

### SUMMARY

Embodiments of the present invention provide a method for determining if an air filter needs to be cleaned and/or replaced based on the operating characteristics of an airflow component and an electronic device that includes the air filter and the airflow component.

In accordance with the first aspect, it provides a method for determining the status of an air filter in an electronic device. The method comprises comparing the amount of power needed to cause at least one airflow component such as a fan to move a predetermined amount of air through at least one air filter to a previous amount of power needed to move the same amount of air through the filter(s). The method further discloses determining the status of the filter(s), based on the comparing of the amount of power needed to cause the airflow component(s) to move the predetermined amount of air both currently and previously, and producing an alert or message when the difference is greater than a threshold.

In accordance with the second aspect, it provides an electronic device comprising at least one airflow component such as a fan and at least one filter for filtering the air being moved by the at least one airflow component. The electronic device further includes a processor for controlling the airflow component(s) and a memory having computer program instructions stored thereon. The processor executes the computer program's instructions in the memory to control the airflow component(s) and compare the amount of power needed to cause the airflow component(s) to move a predetermined amount of air through the filter(s) to a previous amount of power needed to move the same amount of air through the filter(s). The processor then determines the status of the filter(s) based on the comparing of the amount of power needed to cause the airflow component(s) to move the predetermined amount air both currently and previously. The processor produces an alert or message when the difference is greater than a threshold.

In accordance with the third aspect, it provides an information handling system that comprises at least one chassis. The chassis includes one airflow component such as a fan and at least one filter for filtering the air being moved by the at least one airflow component. The chassis further includes a processor for controlling the airflow component(s) and a memory having computer program with instructions stored thereon. The processor executes the computer program instructions in the memory to control the airflow component(s) and compares the amount of power needed to cause the airflow component(s) to move a predetermined amount of air through the filter(s) to a previous amount of power needed to move the same amount of air through the filter(s). The processor then determines the status of the filter(s) based on the comparing of the amount of power needed to cause the airflow component(s) to move the predetermined amount air both currently and previously. The processor produces an alert or message when the difference is greater than a threshold.

### BRIEF DESCRIPTION OF DRAWINGS

FIG. 1 shows a diagram of an information handling system in accordance with one or more embodiments of the invention.

FIG. 2 shows a diagram of computing components in accordance with one or more embodiments of the invention.

FIG. 3 shows a diagram of an airflow device and filters in accordance with one or more embodiments of the invention.

FIG. 4 shows a flowchart of a method of determining an initial power reading in accordance with one or more embodiments of the invention.

FIG. 5 shows a flowchart of a method of detecting current filter status in accordance with one or more embodiments of the invention.

FIG. 6 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for managing components of an information handling system. An information handling system may be a system that provides computer implemented services. These services may include, for example, database services, electronic communication services, data storage services, etc.

To provide these services, the information handling system may include one or more computing devices. The computing devices may include any number of computing components that facilitate providing of the services of the information handling system. The computing components may include, for example, processors, memory modules, circuit cards that interconnect these components, etc.

During operation, these components may be exposed to external environmental/ambient air or gasses used for cooling, that must be filtered to prevent damage to the components. Without proper filtration, over time, containments in the external air used for cooling that may cause the components to fail prior to the computing device meeting its service life goals.

Embodiments of the invention may provide methods and systems to actively monitor the status of an air filter. To determine when an air filter is dirty or clogged, filter monitoring circuits will monitor the amount of power an airflow component, such as a fan, requires to produce a specific amount of airflow. By measuring the power at various points in the filter's life, the amount of clogging of the filter can be determined. If the amount of power needed to operate the airflow component at the specific rate, rises above a preset threshold then the system can notify a user to replace or clean the filter.

By doing so, a system in accordance with embodiments of the invention may be less likely to prematurely fail, and be able to operate in less than ideal environmental conditions and maintain proper functioning of its airflow components.

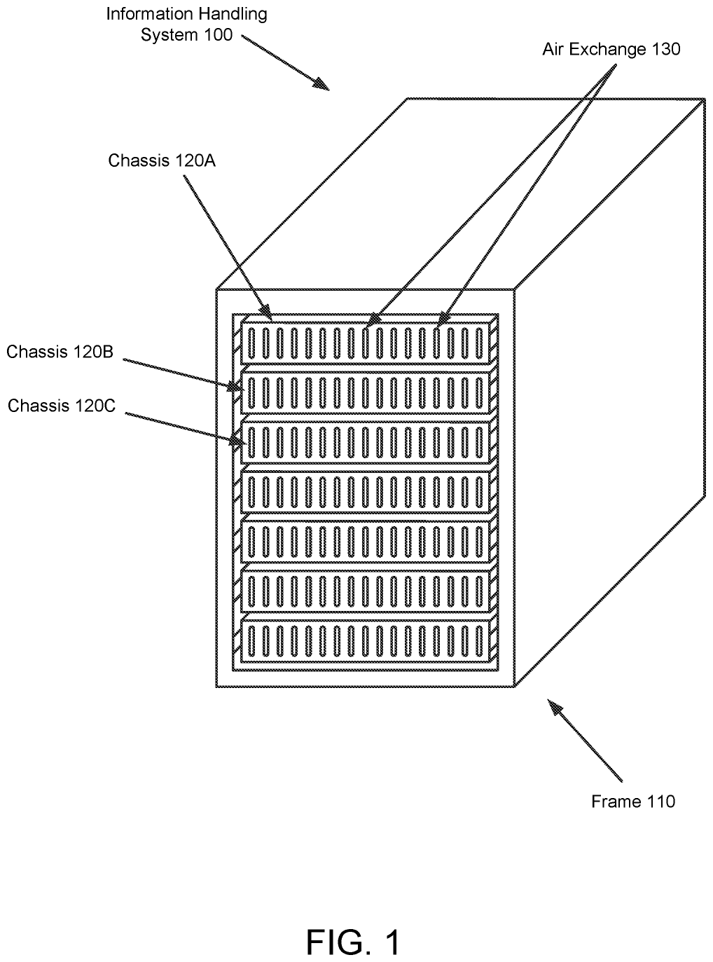

FIG. 1 shows an information handling system (100) in accordance with one or more embodiments of the invention. The system may include a frame (110) and any number of chassis (e.g., 120A, 120B, 120C).

The frame (110) may be a mechanical structure that enables multiple chassis (120A-120C) to be positioned with respect to one another. For example, the frame (110) may be a rack mount enclosure that enables the chassis (120A) to be disposed within it. The frame (110) may be implemented as other types of structures adapted to house, position, orient, and/or otherwise physically, mechanically, electrically, and/or thermally manage chassis. By managing the chassis, the frame (110) may enable multiple chassis to be densely packed in space without negatively impacting the operation of the information handling system (100).

A chassis (e.g., 120A) may be a mechanical structure for housing components of an information handling system. For example, a chassis (120A) may be implemented as a rack mountable enclosure for housing components of an information handling system. The chassis may be adapted to be disposed within the frame (110) and/or utilize services provided by the frame (110) and/or other devices. Any number of components may be disposed in each of the respective chassis (e.g., 120A, 120B, 120C).

When the components of an information handling system provide computer implemented services, the components may generate heat. For example, the components may utilize electrical energy to perform computations and generate heat as a byproduct of performing the computations. If left unchecked, buildup of heat within a chassis may cause temperatures of the components disposed within the chassis to exceed preferred ranges.

The preferred ranges may include a nominal range in which the components respectively operate (i) without detriment and/or (ii) are likely to be able to continue to operate through a predetermined service life of a component. Consequently, it may be desirable to maintain the temperatures of the respective components within the preferred range (e.g., a nominal range).

When a component operates outside of the preferred range, the service life of the component may be reduced, the component may not be able to perform optimally (e.g., reduced ability to provide computations, higher likelihood of error introduced into computations, etc.), and/or the component may be more likely to unexpectedly fail. The component may be subject to other undesirable behavior when operating outside of the preferred range without departing from the invention.

To operate components within the preferred range of temperature, the chassis may include air exchanges (e.g., 130). An air exchange (130) may be one or more openings in an exterior of a chassis that enables the chassis to exchange gases such as air with an ambient environment. For example, a chassis may utilize air exchanges to (i) vent hot air and (ii) intake cool air. By doing so, the temperature of the air within the chassis may be reduced. Consequently, the temperatures of components within the chassis may be reduced by utilizing the cooler gases taken into the chassis via an air exchange.

However, utilizing ambient air to cool components within a chassis may be problematic. The ambient air may not be benign. For example, the air may include gasses that are (i) include chemically reactive components, (ii) include humidity, (iii) include dust or other contaminants, and/or (iii) otherwise interact with components disposed within the chassis in an undesirable manner. The reaction between the gases used to cool the components and the components themselves (or other components proximate to the to-be-cooled components) may negatively impact the components disposed within the chassis.

For example, if the gases include a chemically reactive component (e.g., chlorine species), the gases may react (i.e., chemically react) with portions of the components disposed within the chassis. These reactions may damage portions of the components resulting in a decreased service life of the components.

In another example, if the gases include humidity, the humidity may condense resulting in water being disposed on the surface of the components. When water is disposed on the surface of components (even at very small levels), the water may chemically react with the components forming corrosion. The aforementioned reactions with the condensed water may damage the components or otherwise cause them to operate in an undesirable manner.

In another example, if the gases include dust and other containments, the dust may adhere to the surfaces of the components. This can cause components to overheat due to the dust providing an insulating affect. It can also cause poor contact in relays, switches and connectors. When disposed on the surface of components (even at very small levels), the dust can increase the rate at which humidity condenses on the components. Further dust and water in the gases may chemically react with each other forming corrosive substances, which may damage the components or otherwise cause them to operate in an undesirable manner.

The potential reactions, discussed above, may cause numerous negative impacts.

First, the reactions may impact the electrical conductivity of various components. For example, when metals react with chemically reactive species, condensed water vapor, etc., the metals may form chemical compounds that are substantially less conductive than the pure metals. The reduced conductivities of the components may negatively impact the electrical functionality of the components (e.g., circuits) disposed within the chassis.

Second, the reactions may impact the physical size of various components. For example, when metals chemically react, the products formed by the reactions may occupy significantly larger volumes than the unreacted metals (e.g., metal oxides vs elemental metals). The change in volumes of the reacted metals may negatively impact the electrical functionality of the components by, for example, forming open circuits by physically disconnecting various portions of the components from each other and/or other devices.

The potential reactions may cause other negative impacts beyond those discussed herein. The negative impacts may cause a device to fail prior to meeting its service life. A service life may be a desired duration of operation of a component, device, or system.

To address the above and/or other potential issues, electronic devices such as information handling system (100) include air filters or other types of filters to filter the air for dust and other containments. However, over time these air filters become clogged and no longer efficiently allow air and gasses to pass through them. This requires airflow components to work harder and decrease their lifetimes. The airflow components can then potentially fail to adequately cool electronic components inside of the information handling system.

Embodiments of the invention may provide methods, devices, and systems that manage these filters within a chassis. To determine how to manage the filters within the chassis, a system may monitor the actual rates that the filter is clogged or deteriorated. The measured rates may be used alone or in conjunction with estimated rates of clogging or deterioration not measured directly to ascertain if and when the filter needs replaced or cleaned.

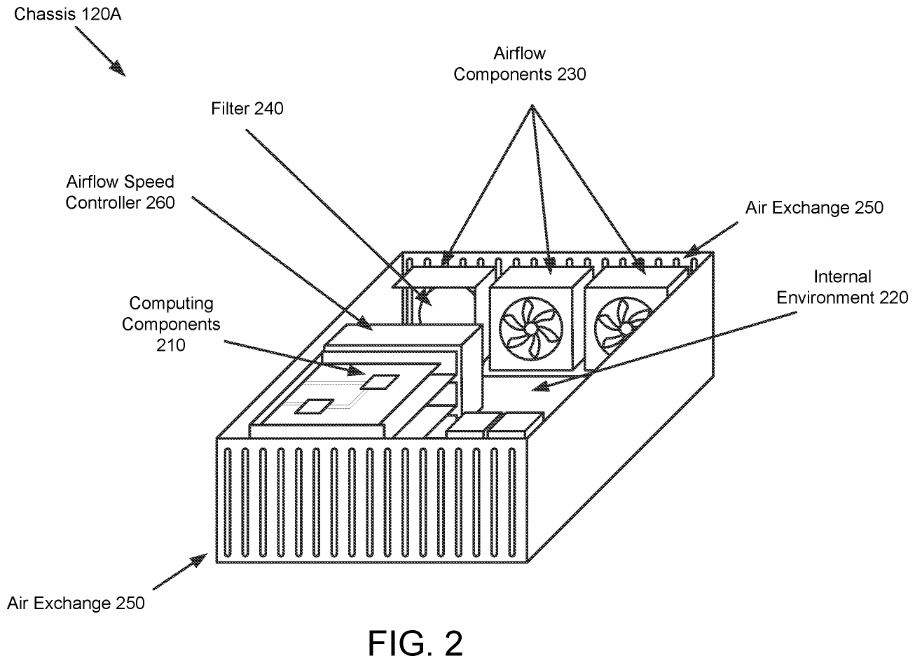

To further clarify the processes of managing the filters along with the environment within the chassis, a diagram of an exemplary chassis is illustrated in FIG. 2.

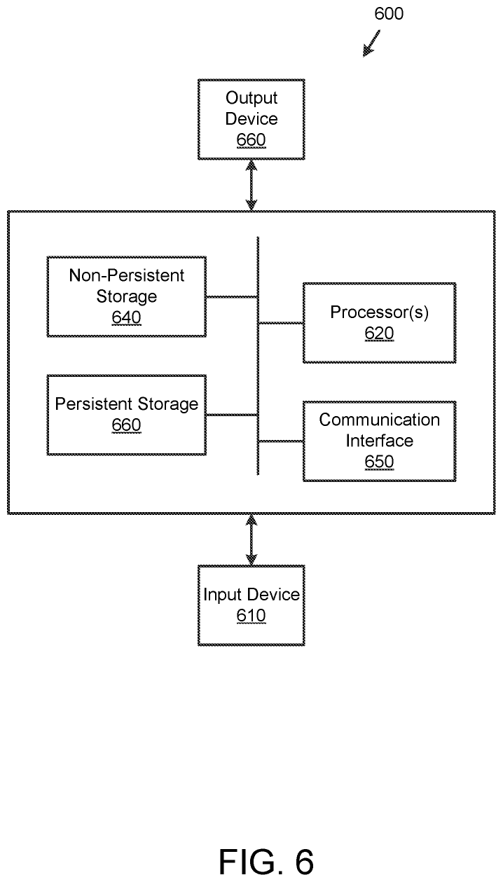

FIG. 2 shows a diagram of a chassis (120A) in accordance with one or more embodiments of the invention. A chassis (120A) may be a portion of an IHS (100) and/or house all, or a portion, of an IHS (see FIG. 1). An information handling system may include a computing device that provides any number of services (e.g., computing implemented services). To provide services, the computing device may utilize computing resources provided by computing components (210). The computing components (210) may include, for example, processors, memory modules, storage devices, special purpose hardware, and/or other types of physical components that contribute to the operation of the computing device. For additional details regarding computing devices, refer to FIG. 6.

While the chassis (120A) of FIG. 2 has been illustrated as including a limited number of specific components, a chassis in accordance with one or more embodiments of the invention may include additional, fewer, and/or different components without departing from the invention. Additionally, while the chassis (120A) is illustrated as having a specific form factor (e.g., rack mount), a chassis in accordance with embodiments of the invention may have different form factors without departing from the invention including as a device that can operate by itself with or without a frame

As discussed above, the chassis (120A) may house computing components (210). The computing components (210) may enable computing devices to provide services, as discussed above. The computing components (210) may include, for example, packaged integrated circuits (e.g., chips). The computing components (210) may enable any number and type of functionalities to be performed by a computing device.

In one or more embodiments disclosed herein, the computing components (210) include storage that is implemented using devices that provide data storage services (e.g., storing data and providing copies of previously stored data). The devices that provide data storage services may include hardware devices and/or logical devices. For example, storage may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, the computing components (210) may include a memory device (e.g., a dual in line memory device) in which data is stored and from which copies of previously stored data are provided. In another example, the computing components (210) may include a persistent storage device (e.g., a solid state disk drive) in which data is stored and from which copies of previously stored data are provided. In another example, computing components (210) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Computing components may consume electrical power and generate heat as a byproduct of performing their functionality. Further, the computing components (210) may have some sensitivity to temperature. For example, the computing components (210) may only operate nominally (e.g., as designed) when the temperatures of the respective components (210) are maintained within a preferred temperature range. Consequently, all, or a portion, of the computing components (210) may require some level of cooling to continue to operate nominally.

Because the computing device uses computing components (210) to provide services, the ability of the computing device to provide services is limited based on the number and/or quantity of computing devices that may be disposed within the chassis. For example, by adding additional processors, memory modules, and/or special purpose hardware devices, the computing device may be provided with additional computing resources which it may be used to provide services. Consequently, large number of computing components that each, respectively, generate heat may be disposed within the chassis.

To maintain the temperatures of the computing components (210) (and/or other types of components) within a nominal range, external air such as ambient air may be taken in through an air exchange (250). The gases forming the external air may be passed by the computing components (210) to exchange heat with them. The heated gases may then be expelled out of another air exchange (250).

However, by taking in and expelling air used for cooling purposes, the components disposed within the chassis (120A) may be subject to degradation due to corrosion and dust. For example, as discussed above, the gases in the air may include components such as humidity that may chemically react with the computing components (210) and/or other types of components disposed in the chassis (120A). The chemical reactions may damage the structure and/or change the electrical properties of the computing components (210). These changes may negatively impact the ability of the computing device to provide its functionality.

For example, the computing device may have a service life during which it is expected that the computing device will be likely to provide its functionality. However, changes in the structure and/or electrical properties of these components due to exposure to humidity or other components of the gases used for temperature regulation purposes may cause the components to prematurely fail ahead of the service life of the computing device.

In general, embodiments of the invention provide methods, devices, and systems for managing the internal environments of chassis by providing filters (240) in combination with airflow components (230) to reduce the likelihood of premature failure of computing components (210) due to dust and corrosion. By providing filters and replacing/cleaning them when dirty/clogged, the method and system prolongs the life of both the airflow components (230) and reduces the likelihood of the occurrence of premature failures of computing components (210) mounted within the chassis (120A). Both the airflow components (230) and the computing components (210) may be more likely to meet their respective service life goals, have lower operation costs, and/or require fewer repairs during their respective service life.

To decide when a filter (240) needs cleaning or replacing, an airflow speed controller (260) may obtain and/or be provided information regarding the operation of airflow components (230). For example, the airflow speed controller (260) may be operably connected to airflow components (230), sensors (unlabeled) and other components via any combination of wired and/or wireless networks.

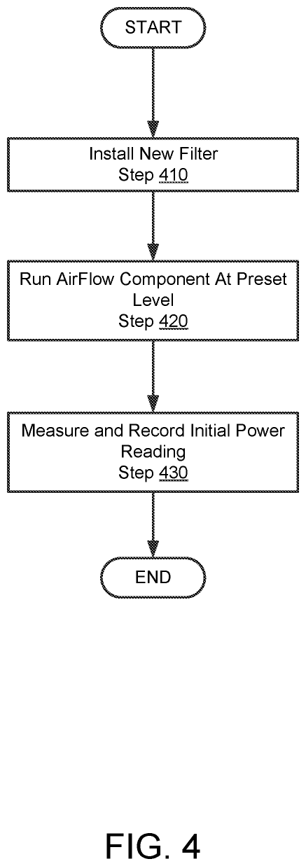

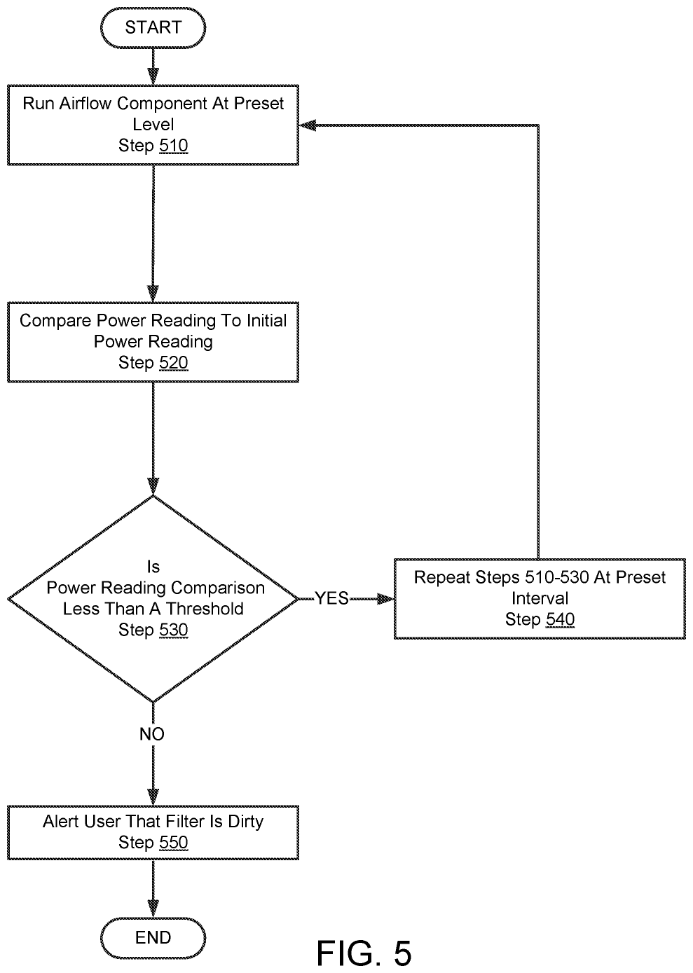

The airflow speed controller (260) may be implemented using a computing device and/or connected to other computing components (210). For additional details regarding computing devices, refer to FIG. 6. The airflow speed controller (260) may perform all, or a portion, of the methods illustrated in FIGS. 4 and 5 while providing its functionality. Alternatively the methods illustrated in FIGS. 4 and 5 can be implemented by other computing components (210) such as an environmental manager (not shown) or other internal environment (220) sensors and controllers.

While illustrated in FIG. 2 as a physical structure, the airflow speed controller (260) may be implemented as a logical entity (e.g., a program executing using the computing components (210)). For example, a computing device disposed in the chassis may host a program that provides the functionality of the airflow speed controller (260).

The airflow components (230) may include gas movers such as fans. The fans may be able to modify the rate of gases being taken into and expelled from the chassis (120A) through the air exchangers (e.g., 250). The rate of intake and exhaust of gases may cause an airflow to be generated within the internal environment (220). The airflow may be used to modify the rate of thermal exchange between the computing components (210) and the internal environment (220) (e.g., an environment proximate to the computing components (210)).

Other environmental control components may include components (not shown) that are not disposed in the chassis (120A). For example, the environmental control components may include an airflow conditioner. These external components may be used in conjunction with the environment control components disposed within the chassis to manage the temperature and/or relative humidity levels throughout the internal environment (220) of the chassis (120A).

The chassis (120A) may include any number and type of environmental control components without departing from the invention. Any of the environmental control components may be implemented using physical devices operably connected to and/or controllable by the airflow speed controller (260) and/or a system environmental managers (alone or in combination). Any number of chassis environmental managers and system environmental managers may cooperatively operate to control the temperature and/or relative humidity levels of the internal environments of any number of chassis to control the rate of corrosion occurring within the chassis and/or manage the thermal load generated by the computing components (210) and/or other components.

The airflow components (230), airflow speed controller (260), and other environmental control components may be a physical devices that are able to, at a granular level, modify characteristics of the ambient environment of a set of one or more computing components (210) without affecting the ambient environment of other computing components outside of the set. The airflow components (230) may be modified in response to a change in ambient environment to enable, or disable, airflow to pass through the set of computing components associated with a specific airflow component (230). The airflow may be an airflow provided by an airflow component (230, e.g., a fan) in the chassis (120A). In enabling, or disabling, the airflow, the temperature of the ambient environment of the set of computing components (210) may be increased or decreased, which may result in a reduction in the rate of change of contamination on the set of computing components while maintaining the nominal range of temperature that is preferred for operability in the set of computing components.

In one or more embodiments of the invention, the airflow speed controller (260) is implemented using a hardware device including circuitry. The airflow speed controller (260) may be implemented using, for example, a digital signal processor, a field programmable gate array, or an application specific integrated circuit. The airflow speed controller (260) may be implemented using other types of hardware devices without departing from the invention.

In one or more embodiments of the invention, the airflow speed controller (260) is implemented using computing code stored on a persistent storage that when executed by a processor performs all, or a portion, of the functionality of the airflow speed controller (260). The processor may be a hardware processor including circuitry such as, for example, a central processing unit or a microcontroller. The processor may be other types of hardware devices for processing digital information without departing from the invention.

The airflow speed controller (260) and/or computing components (210) may include one or more data structures that include information regarding the environmental conditions within a chassis. For example, when temperature data is read from a detector, the read information may be stored in an environmental condition repository. Consequently, a historical record of the environmental conditions in the repository may be maintained.

The historical record of the environmental conditions may include any type and quantity of information regarding the environmental conditions within the repository. For example, an environmental condition repository may include temperature sensor data from discrete temperature sensors and/or temperature sensors integrated into computing components (and/or other types of devices). In another example, the environmental condition repository or any equivalent repository, may include a table of the power level in the form of electrical currents, needed to provide a specific airflow rate as well as changes over time in those currents.

The tables may also include initial factory installed currents as well as more recently measured current amounts needed to provide a specific airflow rate. Consequently, the rates of deterioration of the airflow components (230) and/or their filters (240), which will be described in more detail below with reference to FIGS. 4 and 5, may be ascertained using the information included in the tables.

The data structures may include one or more data structures such as a lifecycle repository that include information regarding the desired life of components disposed in a chassis of an information handling system. For example, the lifecycle repository may specify how much contamination may occur with respect to a specific filter before the respective filter is likely to fail.

While the data structures stored in storage have been described as including a limited amount of specific information, any of the data structures stored in storage may include additional, less, and/or different information without departing from the embodiments disclosed herein. Further, the aforementioned data structures may be combined, subdivided into any number of data structures, may be stored in other locations (e.g., in a storage hosted by another device), and/or spanned across any number of devices without departing from the embodiments disclosed herein. Any of these data structures may be implemented using, for example, lists, tables, linked lists, databases, or any other type of data structures usable for storage of the aforementioned information.

The airflow components (230) may comprise of devices in addition to fans. In one or more embodiments of the invention, the airflow components (230) may include physical devices that include functionality to modify characteristics (e.g., temperature, humidity level, airflow rates/directions) of the ambient environment surrounding the computing components (210) at a more granular level (e.g., without modifying characteristics of other computing components in the chassis (120A)) than that of just a fan.

In one or more embodiments of the invention, the airflow components (230) are implemented as active components. An active component may be a component that utilizes an active actuator to perform the modifications to the ambient environment. Examples of active actuators may include, but are not limited to: motors, heating components, secondary air movers, and/or a cooling component. An airflow control component implemented as an active component may be referred to as an active airflow control component (230).

As discussed above, to facilitate cooling of the hardware devices (142), airflows within the chassis (120A) may be generated by Airflow components such as fans, heaters, etc. The airflows may cause gases that are at different temperatures and/or relative humidity levels to be taken into the chassis (120A), used for cooling purposes, and then expelled from the chassis.

To manage an ambient environment of a computing component, a chassis (120A) in accordance with embodiments of the invention may include an active airflow control component (230) with filtration (provided by filters 240). The airflows are passed through a filter (240) to provide proper filtering and/or conditioning of the air prior to entering the internal environment (220)

In one or more embodiments of the invention, the airflow components (230) include at least one filter (240) mounted in the airflow path of the airflow components (230). This filter (240) can take many forms including but not limited to, HEPA air filters, activated carbon air filters, electrostatic filters, spun glass filters, and ionic air filters. The at least one filter (240) can be formed from polymers such as polyester or in combination with aluminum or other inorganic materials. The filters can include fire retardant material and/or electromagnetic interference (EMI) shielding. The filters can have other properties as needed for the given ambient environment and the specific application of the IHS (100).

While the airflow components (230) and airflow speed controller (260) of FIG. 2 has been described and illustrated as including a limited number of specific components for the sake of brevity, an airflow components (230) and airflow speed controller (260) in accordance with embodiments of the invention may include additional, fewer, and/or different components than those illustrated in FIG. 2 without departing from the invention.

Further, any of the components may be implemented as a service spanning multiple devices. For example, multiple computing devices housed in multiple chassis may each run respective instances of the airflow speed controller (260). Each of these instances may communicate and cooperate to provide the functionality of the airflow speed controller (260).

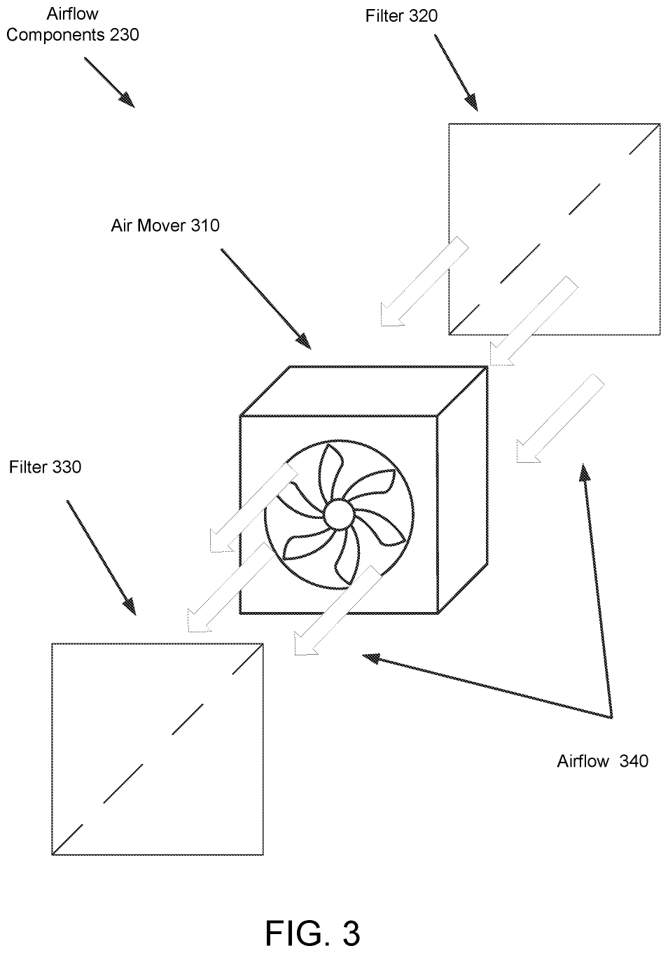

FIG. 3 shows a diagram of an exemplary active airflow control component (300) in accordance with one or more embodiments of the invention. The active airflow control component (300) may be an embodiment of the airflow control component (230, FIG. 2) discussed above.

In one or more embodiments of the invention, the airflow component (300) may include one or more air movers (310). As described above the air movers (310) can take a variety of forms not limited to heating components, secondary air movers, and/or a cooling components. In general the air movers (310) include fans or related devices for moving air. The air movers (310) in at least one embodiment employ rotating blades to create a current of air forming an airflow (340) into and out of the airflow component (300).

Because ambient air can include containments such as dust, a filter (320) is provided in the airflow (340) that enters the air mover (310). Alternatively or in addition, a filter (330) can be provided which filters the air after passing through the air mover (310). The filters (320 and/or 330) can take a variety of forms including but not limited to, HEPA air filters, activated carbon air filters, electrostatic filters, spun glass filters, and ionic air filters, which in general function to remove dust and other containments from the airflow prior to affecting other components in the chassis (120A).

Overtime these filters (320 and/or 330) become saturated with containments such as dust. As the containments build up on the filter, the amount of force needed to move the same amount of airflow through the filters increases. This subsequently puts stress on the air mover as it tries to maintain the same amount of airflow to properly cool components inside of the chassis (120A). Consequently at certain intervals the user needs to either replace or clean the filter, depending on the type of material forming the filter and level of containment present.

One way of addressing the contaminated filters (320 and/or 330) is to replace or clean them on a predetermined schedule. This schedule can be provided by the manufacture or installer of the electronic device. The schedule can be stored in the device's memory and cause a user to be notified by the device when a scheduled replacement/cleaning is due.

In accordance to one or more embodiments of the invention, the electronic device uses a dynamic mechanism for determining when a filter (320 and/or 330) is needed to be replaced or cleaned. This is done by measuring how the amount of current needed to cause an air mover (310) to produce a predetermined amount of airflow changes over time. This relationship between current and the filter's status can be recorded in storage and based on predetermined criteria described in more detail with regards to FIGS. 4 and 5, the data can be used to determine when the user of the device needs to replace or clean the filter.

While the airflow components (300) has been illustrated in FIG. 3 as including specific numbers and types of components, an airflow component (300) in accordance with embodiments of the invention may include different, fewer, and/or additional components without departing from the invention.

FIGS. 4 and 5 show a flowchart of a method in accordance with one or more embodiments of the invention. The method depicted in FIG. 4 may be used to determine the amount of power or current needed for an airflow component to maintain an airflow at a preset level. The method shown in FIG. 4 may be performed by, for example, an airflow speed controller (e.g., 260, FIG. 2). Other components of the system illustrated in FIGS. 1-3 may perform all, or a portion, of the method of FIG. 4 without departing from the invention.

While FIG. 4 is illustrated as a series of steps, any of the steps may be omitted, performed in a different order, additional steps may be included, and/or any or all of the steps may be performed in a parallel and/or partially overlapping manner without departing from the invention.

In step 410, a new filter is installed. The filter may be disposed in the chassis or alternatively on the outside covering the air exchange (e.g., 130, FIG. 1). This step can be performed at the factory or alternatively when the device is first installed at a customer's location.

In step 420, an air mover such as a fan associated with the specific filter is activated and operated at a preset level. In one or more embodiments of the invention, this may be at the maximum airflow for which the air mover is rated. Alternatively. it can be at any predetermined airflow rate in which deterioration of the filter will have an effect on the operation of the air mover.

In step 430, the amount of power or other easily measured criteria needed to initially operate the air mover at the preset level is recorded. This amount of power is recorded in a table such as a LUT or other similar components as an initial power reading. This step can be repeated for each filter/air mover combination or alternatively be performed only once at the manufacturer characterizing the ideal initial power reading needed to produce a preset amount of airflow when the filter is new and ideal.

The method of FIG. 4 may end following step 430.

FIG. 5 shows a flowchart of a method in accordance with one or more embodiments of the invention. The method depicted in FIG. 5 may be used to determine when a filter needs cleaned and/or replaced in accordance with one or more embodiments of the invention. The method shown in FIG. 5 may be performed by, for example, an airflow speed controller (e.g., 260, FIG. 2). Other components of the system illustrated in FIGS. 1-3 may perform all, or a portion, of the method of FIG. 5 without departing from the invention.

While FIG. 5 is illustrated as a series of steps, any of the steps may be omitted, performed in a different order, additional steps may be included, and/or any or all of the steps may be performed in a parallel and/or partially overlapping manner without departing from the invention.

In step 510, the air mover associated with the specific filter is activated and run at the preset level. In one or more embodiments of the invention, this may be at the maximum airflow for which that the air mover is rated. Alternatively, it can be at any predetermined airflow rate in which deterioration of the filter will have an effect on the operation of the air mover and should correspond to the airflow rate used in the initial power reading.

In step 520, the amount of power or other easily measured criteria needed to operate the air mover at the preset level is recorded and compared to the initial reading. The amount of of power needed to provide the preset amount of air flow should be greater than that of the initial power reading, e.g., due to blockage of the filter. A difference between the two aforementioned reading may be determined.

In one embodiment this difference can be converted into a percentage. For example if the initial power reading is 0.5 A and the subsequent measurement is 0.7 A then the difference would be 0.2 A. This would correspond to a 40% increase in current needed to operate the air mover at the preset level. The invention is not limited to this example.

In step 530, the result of the comparison is compared to a threshold. The threshold can be determined by the manufacturer or, alternatively, can be set by a user or a combination of the user and the manufacturer. If the amount of increase in the power needed to operate the air mover at the preset level is greater than or equal to the threshold, this is an indication that the filter is needs to be cleaned or replaced as appropriate for the particular filter being used.

For example, in a non-limiting example, if the particular air mover and filter combination is such that a 50% increase in current indicates that the air mover and/or filter will fail, the manufacture/user can set the threshold at a number such as 40% to insure that the filter is replaced prior to the air mover and/or filter being damaged.

In step 540, if the result of the comparison is such that the power reading is less than a threshold, steps 510-530 are repeated at a preset interval. This interval can be continuous or less often. The interval can be set by a manufacture and/or user such that it provides adequate warning that the filter needs cleaned/replaced while minimizing the amount of the stress put on the air mover and other components. Further, steps 510-530 may also be performed each time a filter is cleaned and/or replaced.

In step 550, if the result of the comparison is such that the power reading is greater than the threshold, then a user or other concerned party is notified that maintenance needs to be performed on the filter and/or that the filter is dirty. The user can then replace or clean the filter as required based on the specific filter and environment in which it is employed. Alternatively, a computing component in the chassis can notify (via an alert or message) an outside party (e.g., an administrator) that maintenance needs to be performed on at least the filter allowing maintenance personnel to schedule appropriate service to the device and/or filter.

These steps can be repeated for each filter/air mover combination or alternatively be performed on only one filter/air mover combination that can be considered to characterize all of the air filter/air mover combinations in a particular chassis. Additionally, while in the aforementioned embodiment, only the air filter(s) are replaced/cleaned, it is within the scope of this invention that other components of the Airflow component such as the air mover may also need to be replaced/cleaned.

Additionally, as discussed above, embodiments of the invention may be implemented using a computing device. FIG. 6 shows a diagram of a computing device in accordance with one or more embodiments of the invention. The computing device (600) may include one or more computer processors (620), non-persistent storage (640) (e.g., volatile memory, such as random access memory (RAM), cache memory), persistent storage (660) (e.g., a hard disk, an optical drive such as a compact disk (CD) drive or digital versatile disk (DVD) drive, a flash memory, etc.), a communication interface (650) (e.g., Bluetooth interface, infrared interface, network interface, optical interface, etc.), input devices (610), output devices (660), and numerous other elements (not shown) and functionalities. Each of these components is described below.

In one embodiment of the invention, the computer processor(s) (620) may be an integrated circuit for processing instructions. For example, the computer processor(s) may be one or more cores or micro-cores of a processor. The computing device (600) may also include one or more input devices (610), such as a touchscreen, keyboard, mouse, microphone, touchpad, electronic pen, or any other type of input device. Further, the communication interface (650) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment of the invention, the computing device (600) may include one or more output devices (660), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (620), non-persistent storage (640), and persistent storage (660). Many different types of computing devices exist, and the aforementioned input and output device(s) may take other forms.

Embodiments of the invention may provide an improved method for determining when to replace a dirty/clogged dust filter without using a fixed schedule or the use of additional sensors. To do so, the system compares the difference in airflow component power to determine system impedance and filter fouling level. This avoids needing to replace the filter on a periodic fixed schedule that does not take in to account the environment in which the air flow component and filters are operating in. By doing so, embodiments of the invention may provide a system that improves user experience by allowing the filter to be replaced only when it needs without the additional costs of filter specific sensors.

Thus, embodiments of the invention may address the problem of determining when to replace a dirty/clogged dust filter

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for determining a status of a filter in an electronic device, comprising:
comparing a measured amount of power needed to cause an at least one airflow component to move a predetermined amount of air through the filter with a previously measured amount of power needed to move the predetermined amount of air through the filter;
determining a difference based on the comparing; and
issuing a notification when the difference is greater than a threshold.

2. The method of claim 1, wherein the previously measured amount of power needed to move the predetermined amount of air through the filter, is an initial measurement of the power when the filter is first installed or replaced.

3. The method of claim 2, wherein the initial measurement of the power is measured when the electronic device is manufactured.

4. The method of claim 1, wherein the electronic device is a server.

5. The method of claim 1, wherein the at least one airflow component comprises at least one fan.

6. The method of claim 1, wherein the filter comprises a plurality of filters.

7. The method of claim 1, wherein the comparing is performed on a predetermined schedule.

8. The method of claim 1, wherein the comparing is performed each time the filter is cleaned or replaced.

9. The method of claim 1, wherein the measured amount of power and previously measured amount of power are measurements of an amount of current needed to drive the at least one airflow component to move the predetermined amount of air.

10. An electronic device comprising:
at least one airflow component;
at least one filter for filtering air moved by the at least one airflow component;
a processor for controlling at least the at least one airflow component; and
a memory having computer program instructions stored thereon, the processor executing the computer program instructions in the memory to perform a method, the method comprising:
comparing a measured amount of power needed to cause the at least one airflow component to move a predetermined amount of air through the filter with a previously measured amount of power needed to move the predetermined amount of air through the filter;
determining a difference based on the comparing; and
producing an alert or message when the difference is greater than a threshold.

11. The electronic device of claim 11, wherein the previously measured amount of power needed to move the predetermined amount of air through the filter, is an initial measurement of the power when the filter is first installed or replaced.

12. The electronic device of claim 12, wherein the initial measurement of the power is measured when the electronic device is manufactured.

13. The electronic device of claim 11, wherein the electronic device is a server.

14. The electronic device of claim 11, wherein the at least one airflow component comprises at least one fan.

15. The electronic device of claim 11, wherein the filter comprises a plurality of filters.

16. The electronic device of claim 11, wherein the comparing is performed on a predetermined schedule.

17. The electronic device of claim 11, wherein the comparing is performed each time the filter is cleaned or replaced.

18. The electronic device of claim 11, wherein the measured amount of power and previously measured amount of power are measurements of an amount of current needed to drive the at least one airflow component to move the predetermined amount of air.

19. An information handling system comprising:
at least one chassis comprising:
at least one airflow component;
at least one filter for filtering air moved by the at least one airflow component;
a processor for controlling at least the at least one airflow component; and
a memory having computer program instructions stored thereon, the processor executing the computer program instructions in the memory to perform a method, the method comprising:
comparing a measured amount of power needed to cause the at least one airflow component to move a predetermined amount of air through the filter with a previously measured amount of power needed to move the predetermined amount of air through the filter;
determining a difference based on the comparing; and
producing an alert or message when the difference is greater than a threshold.

20. The information handling system of claim 19, wherein the measured amount of power and previously measured amount of power are measurements of an amount of current needed to drive the at least one airflow component to move the predetermined amount of air.
